(19) United States
(12) Patent Application Publication
(10) Pub. No.: US 2012/0211099 A1
(43) Pub. Date: Aug. 23, 2012

(54) PNEUMATIC MANIFOLD

(75) Inventor: Mark Julian STOCKDALE, Cambridge (GB)

(73) Assignee: ION SCIENCE LIMITED, ROYSTON (GB)

(21) Appl. No.: 13/400,367

(22) Filed: Feb. 20, 2012

(30) Foreign Application Priority Data
Feb. 21, 2011 (GB) 1102909.7

(51) Int. Cl. F15B 21/00

(52) U.S. Cl. 137/560; 137/561 R; 29/592

(57) ABSTRACT

A pneumatic manifold which can be constructed using standard PCB (Printed Circuit Board) construction techniques provides customised flow distribution around (and/or between) different members. By virtue of its PCB construction the manifold also may include conductive electrical tracks and fixing points common to other PCBs and possibly serving electrical pneumatic components.

### CROSS-REFERENCE TO RELATED APPLICATIONS

The present application is based on and claims priority from GB 1102909.7 which was filed on 21 Feb. 2011 and is herein incorporated by reference in its entirety.

1. Field

This invention relates to pneumatic manifolds and especially to application-specific assemblies of specialised channels.

2. Background

When distributing gases, manifolds are used to reduce the number of pipe connections, which otherwise take up much space and cause difficulties in assembly and servicing.

There are two main types of manifolds.
1. Common supply feed. Pneumatic devices are situated along this common feed and control gas into isolated local zones. This is easy to manufacture being a common hole through a length of material and controlled drop-offs break into this feed through the pneumatic devices.
2. Specialised channels specific to application. These are much more difficult to manufacture. They often involve cross drillings through a block which require blocking-off, afterwards creating voids of unswept dead volumes, which may cause severe misshaping of step changes in gas concentrations. Other techniques employ the use of machined plastics often based upon polyacrylics, which need costly specialised diffusion bonding to join the layers together.

### SUMMARY

There is provided a pneumatic manifold including at least two substrate layers, wherein at least one layer bears at least one groove which is closed by a second juxtaposed layer to form a gas channel. The invention is particularly useful when the manifold includes several interconnecting gas channels in the same or different layers. Preferably, at least one layer, and particularly all the layers, is or are a printed circuit board (PCB) or boards, with or without conductive tracking.

According to another aspect, there is provided a method of making a pneumatic manifold comprising forming at least one groove in a laminar substrate and bonding another substrate thereto so as to close the groove and form a gas channel.

The pneumatic manifold may be constructed using readily available production processes employed in the manufacture of multiplayer printed circuit boards (PCBs), in order to reduce costs and enable mass production of specialised pneumatic manifolds. An advantage over existing manifolds may be the possibility of attaching electrical circuits or components on or within the pneumatic manifold.

The invention consists of using various thickness substrate layers and machining physical channels that either partially penetrate or fully penetrate the layers, that are then brought together as juxtaposed layers with pre-preg (glue) to seal these channels between the various ports to adjacent layers that may or may not connect to a pneumatic device or fitting.

It will be appreciated that “juxtaposed” does not imply any particular orientation of the manifold or of the individual layers, other than one layer serving to close the groove or grooves on another layer in order to constitute the gas channels.

At least one layer may have additionally on its surface or embedded therein, for example in at least one of the grooves, at least one electrically conductive path or track to facilitate electrical circuits, as is presently done in conventional PCBs.

The manifold may include at least one hole through a layer and communicating with a groove in another layer. In particular, the manifold may include at least three layers, and at least one hole communicates with grooves in two different layers.

The manifold may include on an external face at least one access port communicating with a gas channel. Advantageously, the access port is adapted to receive an external module, which may be pneumatic or electrical.

The access port may be associated with a seal between the external module and the manifold. The seal may be, for example, an adhesive, O-ring, clip or clamp. Alternatively, the seal may comprise a flat compressive seal or the external module may be a press- or interference-fit within the access port. Preferably, the external module can be screwed into the access port.

Especially if conventional PCB manufacturing techniques are employed, the groove may be substantially rectangular in section, for example square cut.

A pneumatic manifold which can be constructed using standard PCB construction techniques provides customised flow distribution around (and/or between) different members. By virtue of its PCB construction, as indicated above the manifold also may include conductive electrical tracks and fixing points common to other PCBs and possibly serving electrical pneumatic components.

### BRIEF DESCRIPTION OF THE DRAWINGS

The invention will now be described further, by way of example, with reference to the accompanying drawings, in which:

FIG. 1 is a schematic of an exemplary pneumatic circuit;

FIG. 2 is an elevation of a pneumatic manifold realising the circuit of FIG. 1; and

FIG. 3 is a section of the manifold on the line A-A′ of FIG. 2.

### DESCRIPTION OF AN EMBODIMENT

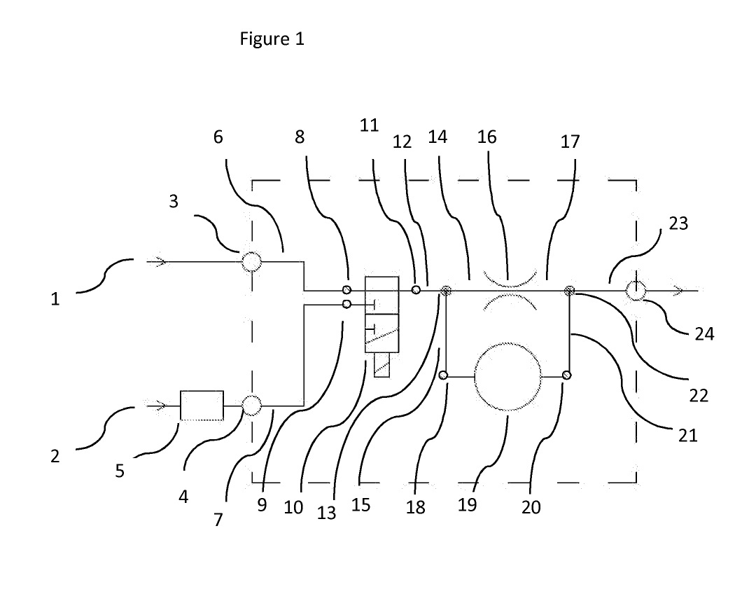

A simple pneumatic circuit for switching between one gas source and another and measuring the gas flow emanating downstream from the circuit is shown schematically in FIG. 1. Two gas sources, 1 and 2, are connected by means of conduits to inlet barb 3 and inlet O-ring push-fit seal 4, respectively. Gas source 2 first passes through a filter 5 pushed into the O-ring seal 4. From barbs 3 and O-ring seal 4, the gas sources are led by conduits 6 and 7 respectively to gas switch junctions 8 and 9 respectively. These are also connected to the inlets of a three port valve 10, which by means of electrical circuitry (not illustrated) opens and closes internal ports so as to cause either gas source 1 and 2 to exit to junction 11, which connects to conduit 12. Conduit 12 is also connected to junction 13, which also connects conduits 14 and 15. Conduit 14 connects to a restrictor 16, which may by way of example be a length of restricted conduit, or a needle valve, from which connects conduit 17. Conduit 15 connects with junction 18. A differential pressure sensor 19 is connected between this junction and junction 20, which also connects with conduit 21. Conduit 21 and 16 connect at conduit junction 22 with conduit 23, from which gas moves downstream to outlet gas barb 24.

Gas has unrestricted access to sensor 19 from conduit 15 and 21 but no gas flows through it. By this means it measures the pressure differential induced by the flow of a gas through the other pneumatic arm 14, 16, 17. From this pressure differential the flow of gas exiting the three port valve 10 may be inferred.

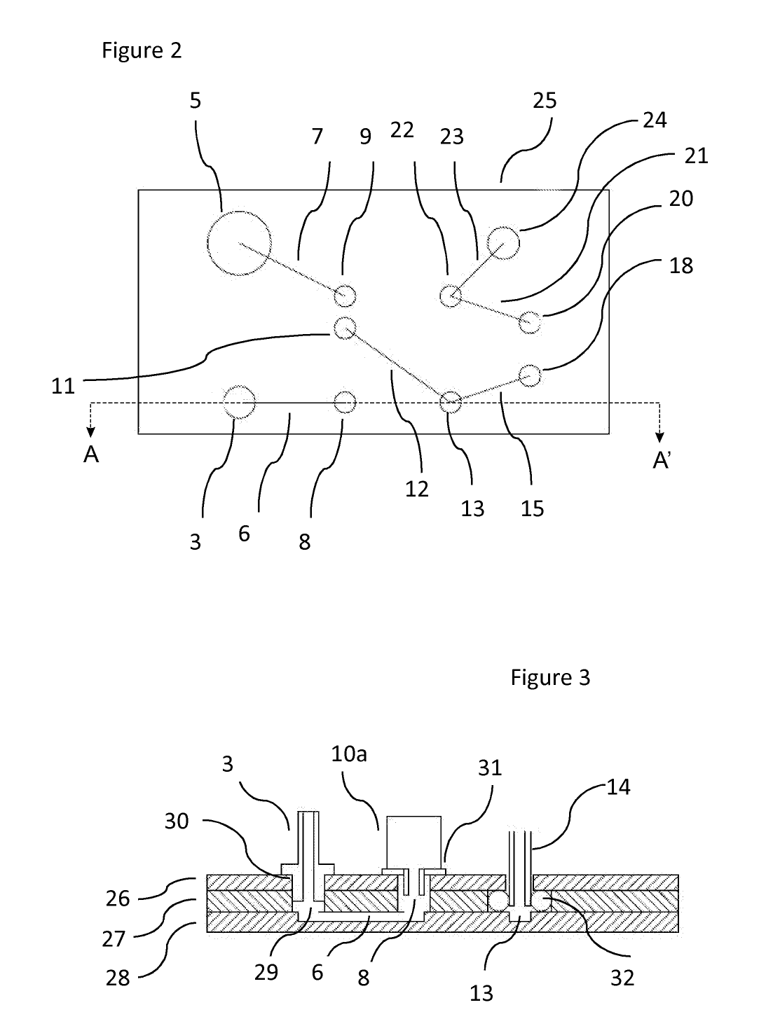

The circuitry shown in FIG. 1 can be realised on the pneumatic circuit board provided by the invention as depicted in FIG. 2. The manifold 25 is shown from the front face of a circuit board, with an indication where the filter 5 would be positioned on the board. The three port valve 10, restrictor 16, and sensor 19 are not shown but would be connected to the board at the junctions 8 and 13 and as described for FIG. 1. Conduits 6, 7, 12, 15, 21 and 23 are contained within the pneumatic circuit board as provided by the present invention, and shown in FIG. 2 as lines connecting the various junctions and inlets 3 and 4 and outlet 24.

Turning now to FIG. 3, the pneumatic manifold provided by the present invention is shown in cross-section, which, by way of example, corresponds to the cross section containing components 3, 6, 8 and 13 as positioned in FIG. 2. The manifold comprises a laminate of three layers built up as a circuit board, which for convenience will hereinafter be referred to as the top layer, 26, the middle later 27 and the bottom layer 28. Conduit 6 is formed by a rectangular, for example square cut, groove in bottom layer 28. The gas tight enclosure provided by layers 26 and 27 ensures gas is led through this channel. At 29 a cavity in middle layer 27 and top layer 26 forms an access port which enables the barb inlet 3 to be affixed, by means of an adhesive (or o-ring, screw thread or flat compressive seal) such as at the contact surface 30. A similar seal would be commonly appropriate in the connection of the outlet 24 to the pneumatic circuit board.

One of the two inlet ports 10a is inserted in junction 8, a seal in this case being provided by means of compression of the top face of the inlet port, 31 against top layer 26. A similar type of compression seal would be commonly appropriate for the other three port valve seals at junctions 9 and 11, by means of a bracket that causes the component to be pressed against the top pneumatic circuit board layer 26.

By way of illustration a further type of seal is provided at junction 13, wherein excavations in the layers of the circuit board cause an O-ring 32 placed in middle layer 27 to be confined and to cause a gas tight seal when restrictor conduit 14 is inserted through it. A similar type of connection may be effective at the other end of the restrictor, and in the connection of the filter 5 and sensor 19 to the circuit board 26.

It should be further remarked that the pneumatic circuit board could support electrical tracks analogous to those commonly used in electrical printed circuit boards.

Linear dimensions of the pneumatic circuit board will be determined by the application and by the available space. Conveniently, each layer is typically 1 to 1.5 mm across providing a total thickness for a three-layer board of some 3-5 mm. The skilled reader will appreciate that these dimensions are not limiting.

Possible features include:

1. Reduced cost by using readily available electronic industry production capacity.

2. Creating any pneumatic circuit by merely building up the layers and using internal pneumatic blind vias.

3. Entrapping O-rings within the layers to enable the easy insertion and extraction of pneumatic devices.

4. Electric tracks can be readily embedded on or within the PCB manifold to neatly take electric controls to where they are locally required without the tangling of over-hanging wire looms.

5. The manifold can be made smaller than its equivalent counterparts because the pneumatic and electrical channels can be brought in locally to a pneumatic device and have simple PCB mounted connections.

6. Local electronic signalling and power control condition circuits may be employed directly adjacent to the pneumatic sensors and control, hence reducing wire harnesses.

7. A small volume of test gas within the manifold may enable its more rapid conveyance at a given flow rate to any component downstream of the manifold.

8. A consistency of dimensions of all gas walls including conduit and gas unions may enable consistency in restrictiveness in gas flow presented by the manifold, in consequence of which gas flow conditions and parameters such as the gas pressure drop across the manifold are invariant.

7. Exploitation of intrinsically convenient features of PCBs, such as custom shaping of the board to suit the component's immediate environment, and its flat shape which allows easily assembly of the gas manifold with electrical PCBs, thereby reducing the size of the assembly and enabling easy assembly.

It is possible to employ all the standard coupling techniques used both in the pneumatic industry (for example screw threaded fittings) together with the standard electrical fittings (multi-pole wired connectors) together with electrical and electronic components all mounted on the one manifold substrate.

1. A pneumatic manifold including at least two substrate layers, wherein at least one layer bears at least one groove which is closed by a second juxtaposed layer to form a gas channel and including on an external face at least one access port communicating with a gas channel, which access port is adapted to receive an external module.

2. A pneumatic manifold including at least two substrate layers, wherein at least one layer bears at least one groove which is closed by a second juxtaposed layer to form a gas channel and including (a) on an external face at least one access port communicating with a gas channel, which access port is adapted to receive an external module, and also including (b) at least one electrically conductive path or track on or embedded in at least one layer.

3. A pneumatic manifold as claimed in claim 2 including several interconnecting gas channels.

4. A pneumatic manifold as claimed in claim 1 including at least three layers and at least one hole through at least two layers and communicating with grooves in two different layers.

5. A pneumatic manifold as claimed in claim 1 wherein the access port is associated with a seal between the external module and the manifold.

6. A pneumatic manifold as claimed in claim 5 wherein the seal comprises an adhesive.

7. A pneumatic manifold as claimed in claim 5 wherein the seal comprises an O-ring.

8. A pneumatic manifold as claimed in claim 5 wherein the seal comprises a flat compressive seal.

9. A pneumatic manifold as claimed in claim 5 wherein the seal comprises a clip or clamp.

10. A pneumatic manifold as claimed in claim 1 wherein the external module is a press- or interference-fit within the access port.

11. A pneumatic manifold as claimed in claim 1 wherein the external module can be screwed into the access port.

12. A pneumatic manifold as claimed in claim 1 wherein the groove is substantially rectangular in section.

13. A pneumatic manifold as claimed in claim 1 wherein at least one layer is a printed circuit board.

14. A method of making a pneumatic manifold comprising forming at least one groove in a laminar substrate and bonding another laminar substrate thereto so as to close the groove and form a gas channel, wherein an external face bears at least one access port communicating with a gas channel, which access port is adapted to receive an external module.
